(19) United States
(12) Patent Application Publication
(10) Pub. No.: US 2012/0174412 A1
(43) Pub. Date: Jul. 12, 2012

(54) UTILITY KNIFE USING TILTING STATUS THEREOF FOR BLADE SWITCHING

(76) Inventor: CHUN-FENG HO, Taichung City (TW)

(21) Appl. No.: 13/345,656

(22) Filed: Jan. 6, 2012

Related U.S. Application Data
(63) Continuation-in-part of application No. 13/161,405, filed on Jun. 15, 2011.

(30) Foreign Application Priority Data
Jan. 11, 2011 (TW) 100200611

(51) Int. Cl. B26B 1/08; B26B 5/00

(52) U.S. Cl. 30/152

(57) ABSTRACT

A utility knife using tilting status thereof for blade switching of the present invention comprises a housing, a blade slider, a switch actuator and a pair of blades. By tilting the housing, one of the pair of blades is capable of moving together with the blade slider. Accordingly, the present invention has advantages and effects of quick switch of the blades for use and convenient carrying.

### CROSS REFERENCE TO RELATED APPLICATIONS

The present application is a continuation-in-part of a U.S. patent application Ser. No. 13/161,405, filed on Jun. 15, 2011, the disclosure of which is incorporated by reference herein.

### BACKGROUND OF THE INVENTION

1. Field of the Invention

The present invention relates to a utility knife capable of using tilting status thereof for blade switching, and particularly to a utility knife utilizing a tiled housing thereof to switch blades of the utility knife, and such utility knife has advantages and functions of quickly switching blades for use and convenience to carry, etc.

2. Related Art

Conventional utility knifes generally are designed to have a blade fixed to a blade sliding holder so as to allow the blade to be extendable out of a shell of the utility knife or retractable therein by moving the blade sliding holder.

Unfortunately, conventional utility knifes can only be equipped with one blade for use. When the blade becomes worn out and dull in use or different blades are in need, it is necessary to replace the original blade with another blade by detaching the original blade from the blade sliding holder and replacing with another blade. It is rather inconvenient for use.

Furthermore, it is rather inconvenient and time-consuming to replace a blade in the above-mentioned way when continuously and alternately using different types of blades is necessary for particular work content. Generally speaking, under such circumstances, two or more utility knifes are prepared to perform such work content for the sake of saving time. However, such working way further causes problems of inconvenient carrying and higher cost, etc.

Hence it is imperative to invent an improved product to overcome the above-mentioned drawbacks and problems.

### SUMMARY OF THE INVENTION

Accordingly, an object of the present invention is to provide a utility knife using tilting status thereof for blade switching, and such utility knife has advantages and effects of quick switch of blades for use and convenient carrying, etc. The present invention can solve drawbacks of inconvenient use of conventional utility knifes equipped with only one blade for use.

In order to solve the above-mentioned problems, the present invention provides a utility knife using tilting status thereof for blade switching, comprising:

a housing defining an internal space therein, an opening, a sliding slot, a pair of first limit portions and a pair of second limit portions;

a blade slider received in the internal space of the housing to slidably move backwards and forwards within the internal space, and to be capable of moving to at least a blade retraction position and a blade protrusion position, the blade slider comprising a first blade compartment and a second blade compartment, a fixing bulge formed in each of the first and second blade compartments;

a slide actuator fixedly disposed on the blade slider, and installed and slidably movable in the sliding slot;

a pair of blades respectively disposed in the first and second blade compartments, each blade of the pair of blades comprising a first concave portion and a second concave portion and being capable of being placed in an operative position and a non-operative position; and

wherein when the housing is tilted towards the first blade compartment, the blade received in the first blade compartment is moved by gravity to be tilted to the non-operative position thereof so as to allow the first and second concave portions of the blade received in the first blade compartment to respectively engage with the pair of first limit portions. Meanwhile, the blade received in the second blade compartment remains in the operative position thereof with the first concave portion thereof engaging with the fixing bulge of the second blade compartment. At this moment, the entire blade slider is capable of advancing forward from the blade retraction position to the blade protrusion position by pushing the slide actuator, and simultaneously moving the blade received in the second blade compartment to extend out of the opening. When the housing is tilted towards the second blade compartment, the blade received in the second blade compartment is moved by gravity to be tilted to the non-operative position thereof so as to allow the first and second concave portions of the blade received in the second blade compartment to respectively engage with the pair of second limit portions, while the blade received in the first blade compartment remains in the operative position thereof with the first concave portion thereof engaging with the fixing bulge of the first blade compartment. In this manner, the entire blade slider is capable of advancing forward from the blade retraction position to the blade protrusion position by pushing the slide actuator, and simultaneously moving the blade received in the first blade compartment to extend out of the opening.

### BRIEF DESCRIPTION OF THE DRAWINGS

FIG. 1 is a schematic exploded perspective view of a utility knife using tilting status thereof for blade switching of the present invention;

FIG. 2 is an assembled perspective view of FIG. 1;

FIG. 3 is a schematic view showing a blade slider of the present invention in a first moving position thereof inside a housing of the present invention;

FIG. 4 is a schematic view showing the blade slider of the present invention in a second moving position thereof inside the housing of the present invention;

FIG. 5 is a schematic partial top plan view of the present invention;

FIG. 6A is a schematic partial top plan view showing the blade slider of the present invention in a first switch position thereof;

FIG. 6B is a schematic partial front elevational view of FIG. 6A;

FIG. 7 is a schematic perspective view showing a first blade of the present invention protruding out of the housing for use when the blade slider is in the first switch position thereof;

FIG. 8A is a schematic partial top plan view showing the blade slider of the present invention in a second switch position thereof;

FIG. 8B is a schematic partial front elevational view of FIG. 8A;

FIG. 9 is a schematic perspective view showing a second blade of the present invention protruding out of the housing for use when the blade slider is in the second switch position thereof;

FIG. 10 is a schematic side view of the utility knife of the present invention showing a storage space thereof;

FIG. 11 is a schematic exploded perspective view of a second embodiment of the present invention;

FIG. 12A is a schematic partial front elevational view showing the second embodiment of the present invention in a first switch position thereof;

FIG. 12B is a schematic partial front elevational view showing the second embodiment of the present invention in a second switch position thereof;

FIG. 13 is a schematic exploded perspective view of a third embodiment of the present invention showing partial components thereof;

FIG. 14A is a schematic partial front elevational view showing the third embodiment of the present invention in a first switch position thereof;

FIG. 14B is a schematic partial front elevational view showing the third embodiment of the present invention in a second switch position thereof;

FIG. 15 is a schematic perspective view showing a position switch of the present invention;

FIG. 16A is a schematic partial perspective view showing the position switch and a position part of the present invention;

FIG. 16B is a schematic partial top plan view showing the position switch and the position part of the present invention;

FIG. 17A is a schematic partial top plan view showing a gravity switch base of the present invention fixed in a first switch position thereof;

FIG. 17B is a schematic partial top plan view showing the gravity switch base of the present invention fixed in a second switch position thereof;

FIG. 18 is a schematic exploded view of the utility knife of the present invention showing the housing thereof in detail; and

FIG. 19 is a schematic exploded view showing partial components of the utility knife of the present invention without the housing.

### DESCRIPTION OF THE PREFERRED EMBODIMENTS

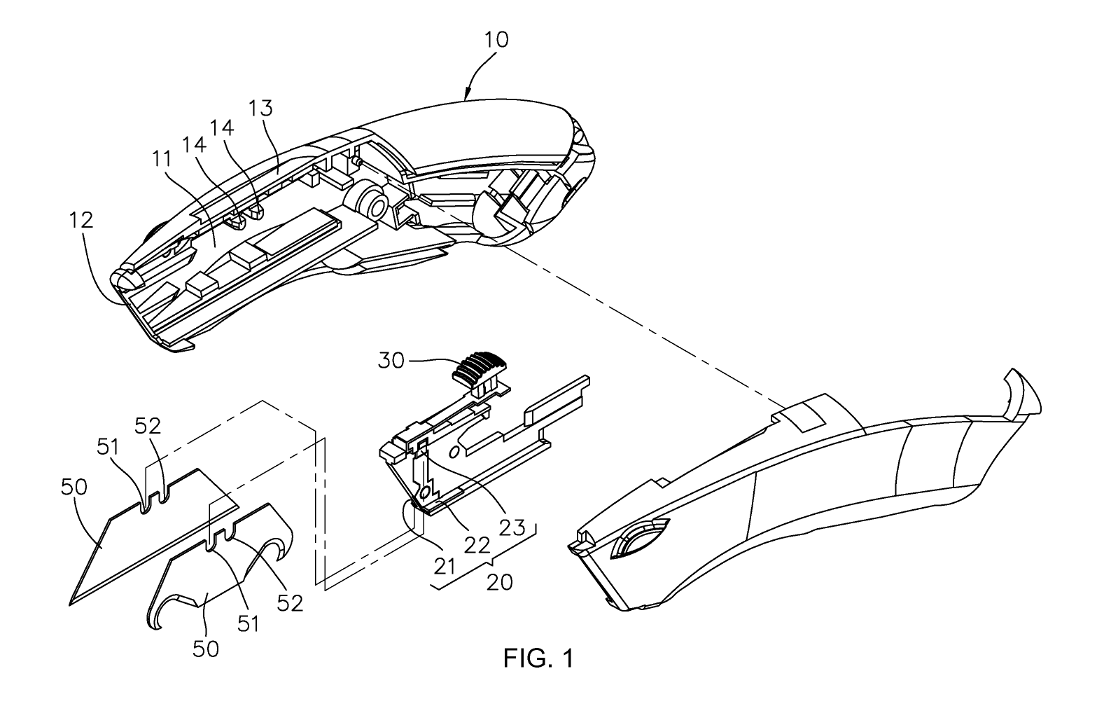

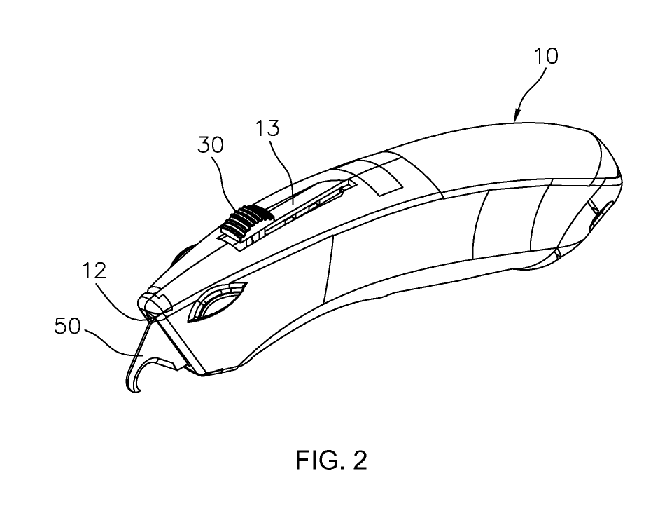

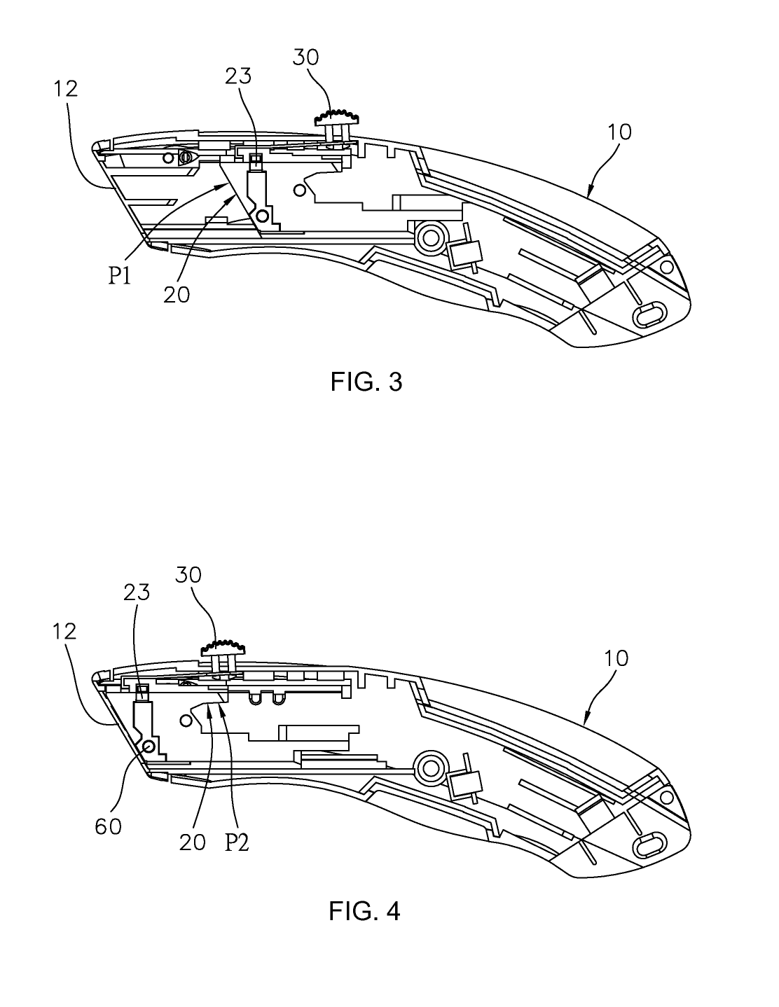

Referring to FIG. 1 to FIG. 9, a utility knife using tilting status thereof for blade switching of the present invention comprises a housing 10, a blade slider 20, slide actuator 30 and a pair of blades 50. The housing 10 defines an internal space 11, an opening 12, a sliding slot 13, a pair of first limit portions 14 and a pair of second limit portions 15 therein.

A blade slider 20 is received in the internal space 11 of the housing 10 to slidably move backwards and forwards within the internal space 11. The blade slider 20 can be at least moved to a blade retraction (first moving) position P1 and a blade protrusion (second moving) position P2. The blade slider 20 comprises a first blade compartment 21 and a second blade compartment 22, and a fixing bulge 23 is formed in each of the first and second blade compartments 21, 22. A width of the opening 12 is equal to (or slightly larger than) a width of the blade slider 20 plus a width of a pair of blades 50.

A slide actuator 30 is fixedly disposed on the blade slider 20 and is installed in the sliding slot 13 to be slidably movable in the sliding slot 13.

The pair of blades 50 are respectively disposed in the first and second blade compartments 21, 22. Each blade of the pair of blades 50 comprises a first concave portion 51 and a second concave portion 52. Each blade 50 is capable of being placed in at least an operative position P5 and a non-operative position P6.

In this manner, when the housing 10 is tilted towards the first blade compartment 21, the blade 50 received in the first blade compartment 21 is therefore moved by gravity to be tilted to the non-operative position P6 thereof so as to allow the first and second concave portions 51, 52 of the blade 50 received in the first blade compartment 21 to respectively engage with the pair of first limit portions 14. Meanwhile, the blade 50 received in the second blade compartment 22 remains in the operative position P5 thereof with the first concave portion 51 thereof engaging with the fixing bulge 23 of the second blade compartment 22. At this moment, the entire blade slider 20 is capable of advancing forward from the blade retraction position P1 to the blade protrusion position P2 by pushing the slide actuator 30, and simultaneously moving the blade 50 in the second blade compartment 22 to extend out of the opening 12. Alternatively, when the housing 10 is tilted towards the second blade compartment 22, the blade 50 received in the second blade compartment 22 is therefore moved by gravity to be tilted to the non-operative position P6 thereof so as to allow the first and second concave portions 51, 52 of the blade 50 received in the second blade compartment 22 to respectively engage with the pair of second limit portions 15, while the blade 50 received in the first blade compartment 21 remains in the operative position P5 thereof with the first concave portion 51 thereof engaging with the fixing bulge 23 of the first blade compartment 21. In this manner, the entire blade slider 20 is capable of advancing forward from the blade retraction position P1 to the blade protrusion position P2 by pushing the slide actuator 30, and simultaneously moving the blade 50 received in the first blade compartment 21 to extend out of the opening 12.

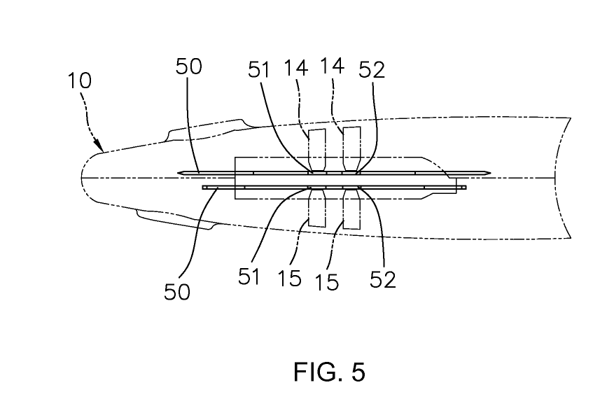

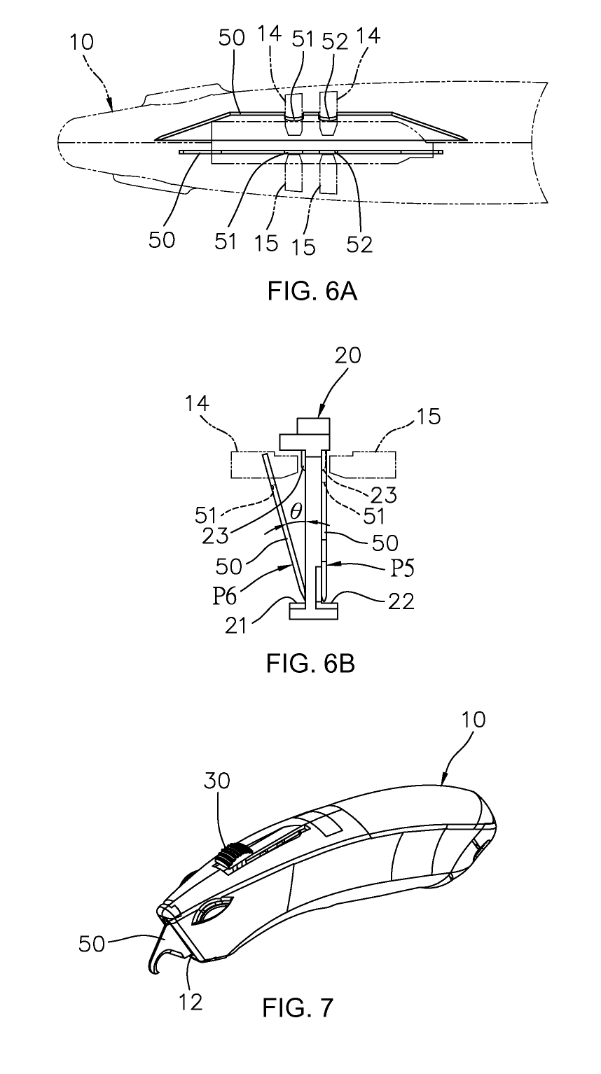

As shown in FIG. 5, the pairs of first and second limit portions 14, are respectively disposed at two opposite sides of the housing 10. As shown in FIGS. 6A and 6B, when the housing 10 is tilted towards the first blade compartment 21, the blade 50 received in the second blade compartment 22 remains in the operative position P5 thereof while the blade 50 received in the first blade compartment 21 is moved by gravity to be tilted to the non-operative position P6 thereof (at a predetermined tilting angle of θ relative to the blade slider 20), and the first and second concave portions 51, 52 thereof respectively engage with the pair of first limit portions 14. In this manner, the blade slider 20 is capable of being moved from the blade retraction position P1 to the blade protrusion position P2 by pushing the slide actuator 30 so as to allow the blade 50 received in the second blade compartment 22 to extend out of the opening 12 (as shown in FIG. 7).

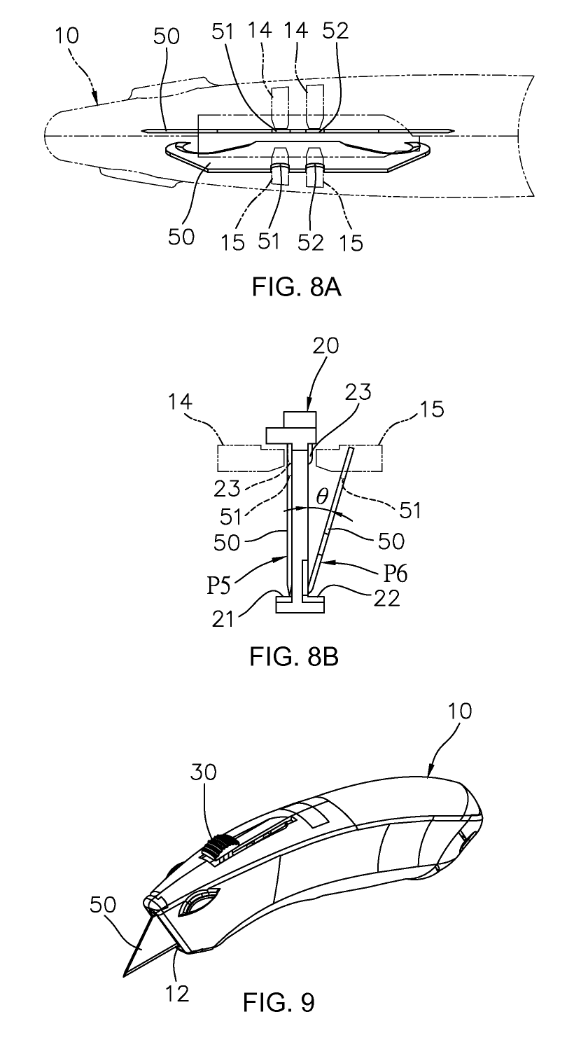

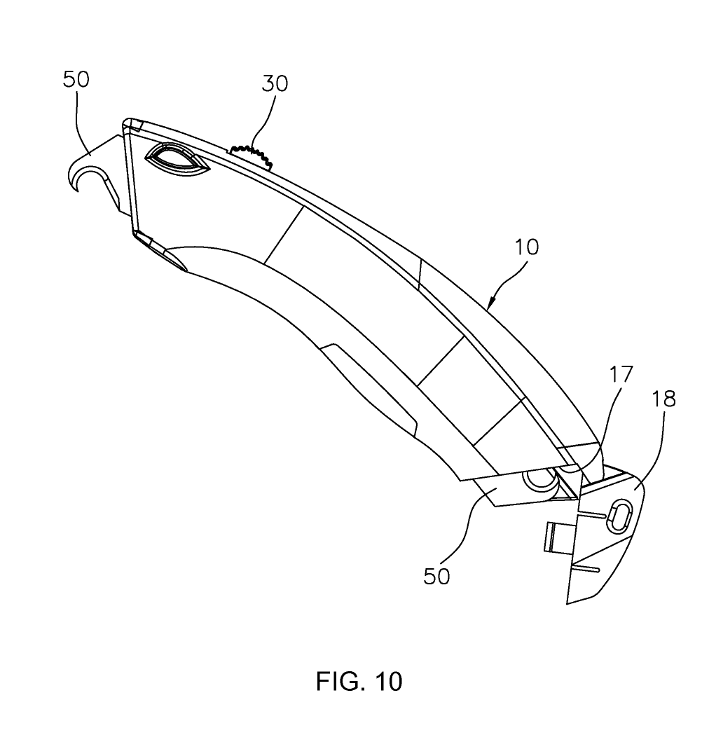

Referring to FIGS. 8A and 8B, when the housing 10 is tilted towards the second blade compartment 22, the blade 50 received in the first blade compartment 21 remains in the operative position P5 thereof while the blade 50 received in the second blade compartment 22 is moved by gravity to be tilted to the non-operative position P6 thereof (at a predetermined tilting angle of θ relative to the blade slider 20), and the first and second concave portions 51, 52 thereof respectively engage with the pair of second limit portions 15. In this manner, the blade slider 20 is capable of being moved from the blade retraction position P1 to the blade protrusion position P2 by pushing the slide actuator 30 so as to allow the blade 50 received in the first blade compartment 21 to extend out of the opening 12 (as shown in FIG. 9)

As understood from the above explanations, the first and second blade compartments 21, 22 of the present invention can be placed with the two blades 50, respectively. The two blades 50 can be of different standards, functions, or shapes. Users can switch the blades 50 at any time during working processes. Certainly, the first and second blade compartments 21, 22 can be placed with two blades of the same standard. When one of the blades 50 is damaged, users can directly switch to another blade and continue working.

Referring to FIG. 10, the housing 10 of the present invention further comprises a storage space 17 and a movable cover 18. The storage space 17 can store a plurality of the spare blades 50 therein, and the movable cover 18 is disposed at an opening of the storage space 17 for opening or closing the storage space 17.

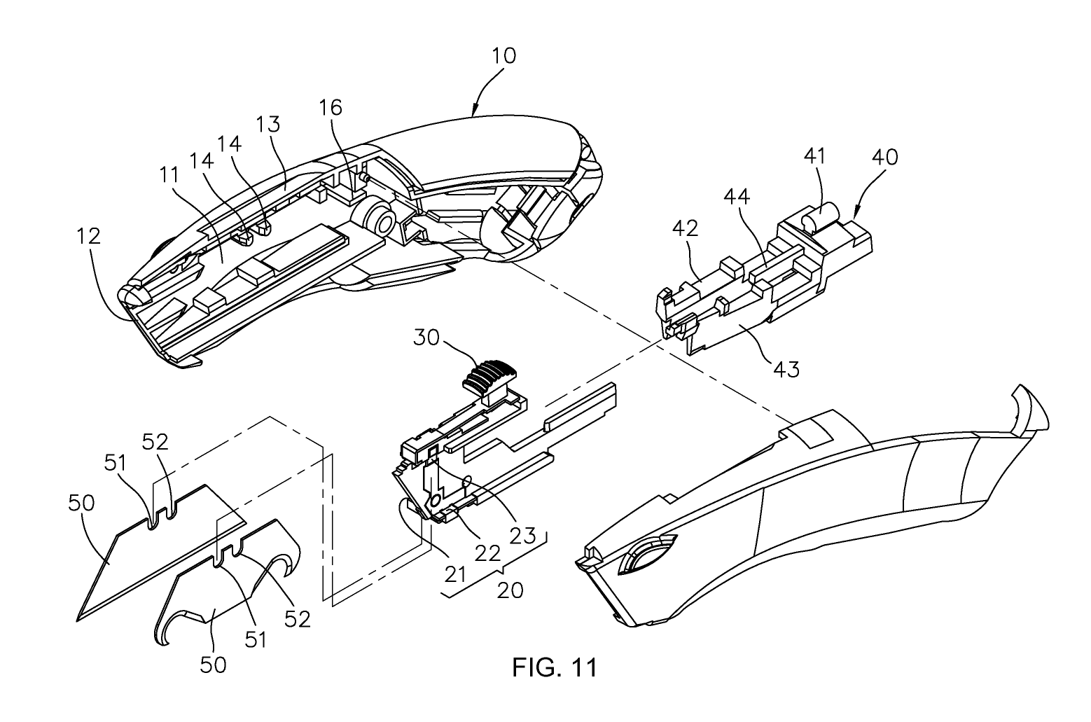

Referring to FIG. 11, the utility knife using tilting status thereof for blade switching according to a second embodiment of the present invention further comprises a gravity switch base 40. The gravity switch base 40 comprises a moving portion 41, a first guiding bar 42, a second guiding bar 43 and a reacting portion 44. The housing 10 further comprises a connecting portion 16, and the moving portion 41 is disposed on the connecting portion 16. The gravity switch base 40 is switchable between a first pushing position P3 and a second pushing position P4 based on the tilting status of the housing 10. When the housing 10 is tilted towards the first blade compartment 21, the gravity switch base 40 is located in the first pushing position P3 so as to allow the reacting portion 44 thereof pushing against the blade 50 received in the first blade compartment 21 toward the non-operative position P6 of the blade 50, and to allow the second guiding bar 43 thereof pushing and maintaining the blade 50 received in the second blade compartment 22 in the operative position P5 of the blade 50. Alternatively, when the housing 10 is tilted towards the second blade compartment 22, the gravity switch base 40 is located in the second pushing position P4 so as to allow the reacting portion 44 thereof pushing against the blade 50 received in the second blade compartment 22 toward the non-operative position P6 of the blade 50, and to allow the first guiding bar 42 thereof pushing and maintaining the blade 50 received in the first blade compartment 21 in the operative position P5 of the blade 50.

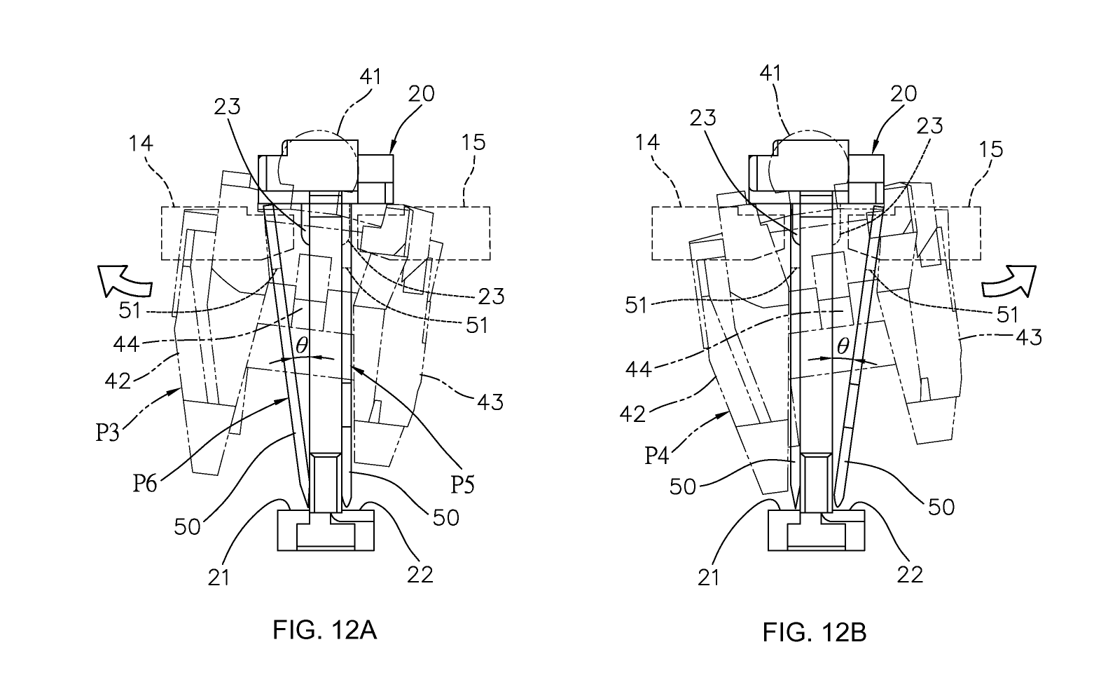

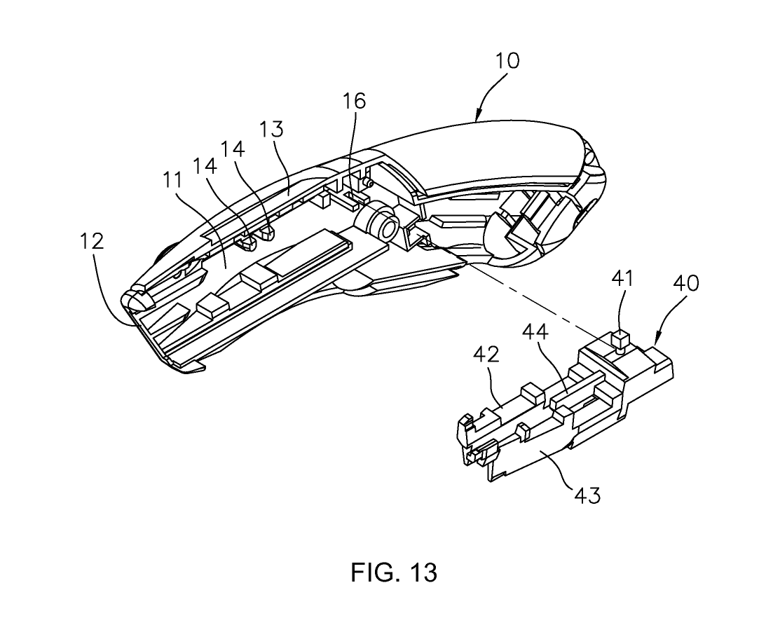

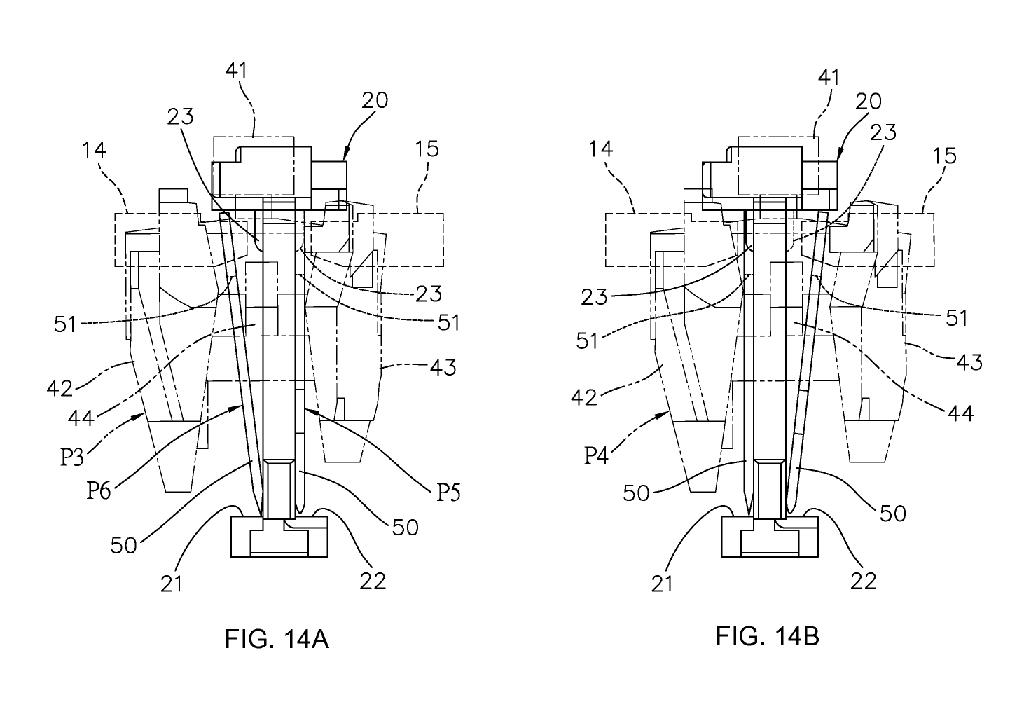

The gravity switch base 40 comprises at least two design types as follows:

[A] pivotally connecting type: As shown in FIG. 11, the moving portion 41 is pivotally connected to the connecting portion 16 of the housing 10 so that the gravity switch base 40 pivotally rotates around the connecting portion 16 to one of the first and second pushing positions P3, P4 (as respectively shown in FIGS. 12A and 12B).

[B] slidably connecting type: As shown in FIG. 13, the moving portion 41 is slidably disposed on the connecting portion 16 of the housing 10 so that the gravity switch base 40 is movable to one of the first and second pushing positions P3, P4 as the moving portion 41 slides (as shown in FIGS. 14A and 14B).

The above-mentioned rotation or sliding of the gravity switch base 40 can be achieved due to tilting of the housing 10. In need of switching the blades 50, simply tilting the housing 10 towards either one of the first blade compartment 21 and the second blade compartment 22 will result in the gravity switch base 40 to rotate or slide naturally due to gravity. Consequently, the unselected one of the blades 50 received in the first and second blade compartments 21, 22 is limited by corresponding one of the pair of first limit portions 14 and the pair of second limit portions 15. When the entire blade slider 20 moves from the blade retraction position P1 to the blade protrusion position P2 by pushing the slide actuator 30, the unselected blade 50 that is limited by the either one of the pairs of first and second limit portions 14, 15 will not move together with the blade slider 20, and the selected blade 50 that engages with the fixing bulge 23 will slide together with the blade slider 20 to extend out of the opening 12.

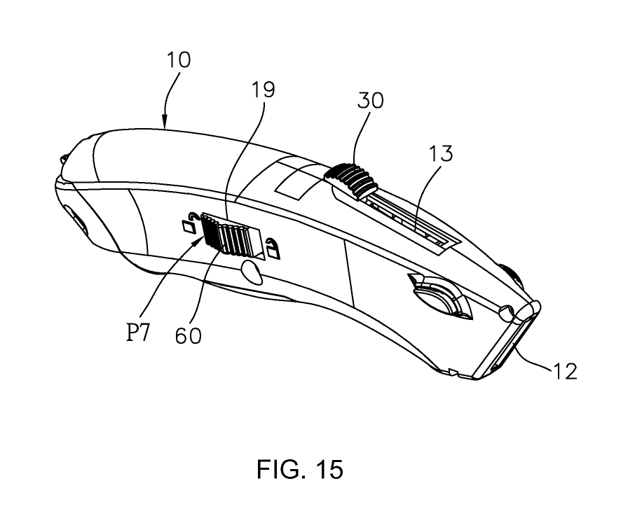

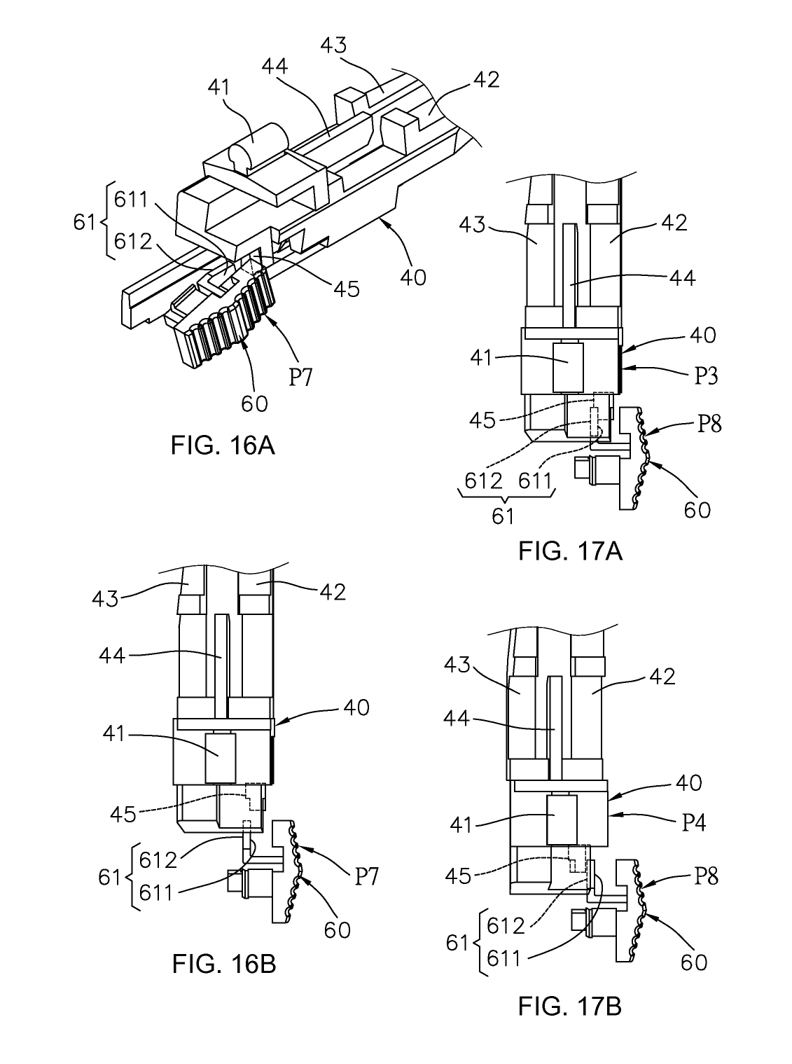

Referring to FIGS. 15, 16A and 16B, in design, the utility knife of the present invention further comprises a position switch 60. The position switch 60 comprises an engaging portion 61 having a first engaging face 611 and a second engaging face 612. Correspondingly, the housing 10 further comprises a switch channel 19, and the gravity switch base 40 further comprises a position part 45. The position switch 60 is slidably disposed in the switch channel 19 and is movable at least between an opening position P7 and an engaging position P8.

Accordingly, referring to FIGS. 16A and 16B, when the position switch 60 is located in the open position P7, the gravity switch base 40 is not limited by the position switch 60 and is able to freely move to the first and second pushing positions P3, P4 thereof. On the other hand, as shown in FIG. 17A, when the gravity switch base 40 is located in the first pushing position P3 thereof, moving the position switch 60 from the open position P7 to the engaging position P8 will result in engagement of the position part 45 of the gravity switch base 40 with the first engaging face 611 of the engaging portion 61 so as to limit and fix the gravity switch base 40 in the first pushing position P3 thereof. Alternatively, as shown in FIG. 17B, when the gravity switch base 40 is located in the second pushing position P4 thereof, moving the position switch 60 from the open position P7 to the engaging position P8 will result in engagement of the position part 45 of the gravity switch base 40 with the second engaging face 612 of the engaging portion 61 so as to limit and fix the gravity switch base 40 in the second pushing position P4 thereof.

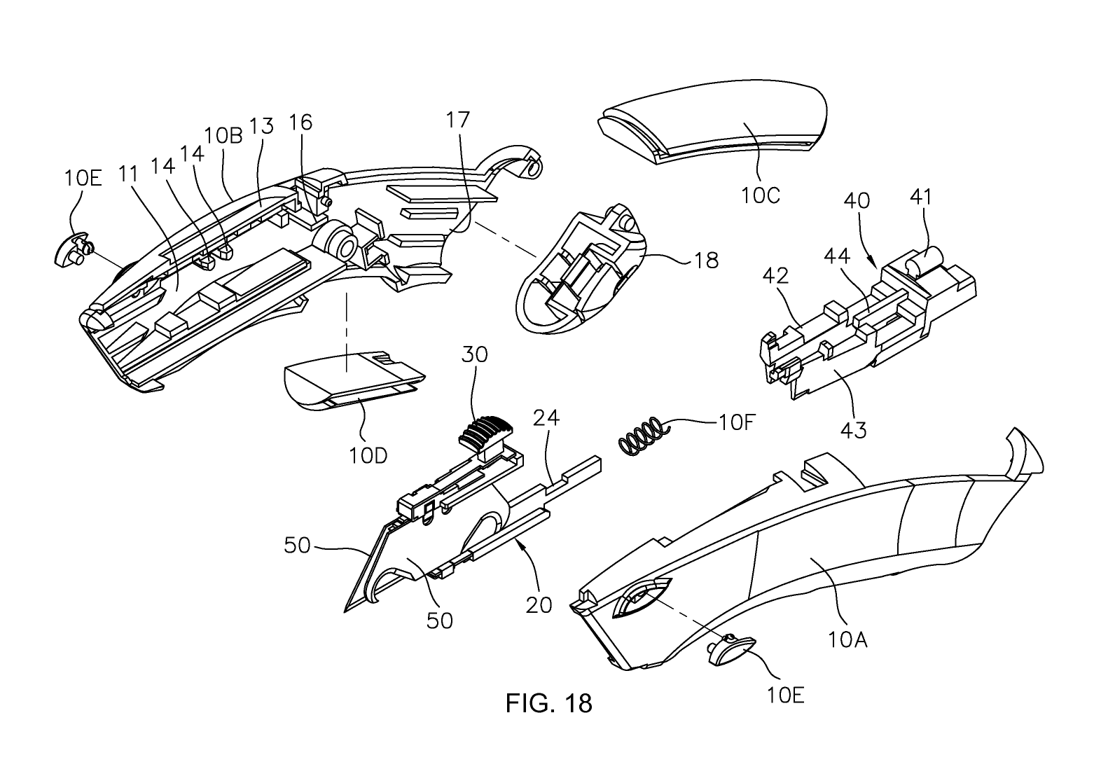

Referring to FIG. 18, which schematically shows an exploded perspective view of the housing 10 of the present invention, the housing 10 comprises a right casing 10A, a left casing 10B, a top cover 10C, a bottom cover 10D, two pushing elements 10E, a resilient element 10F, and the movable cover 18. The resilient element 10F utilizes resilient force thereof to maintain the movable cover 18 in a position to close the storage space 17.

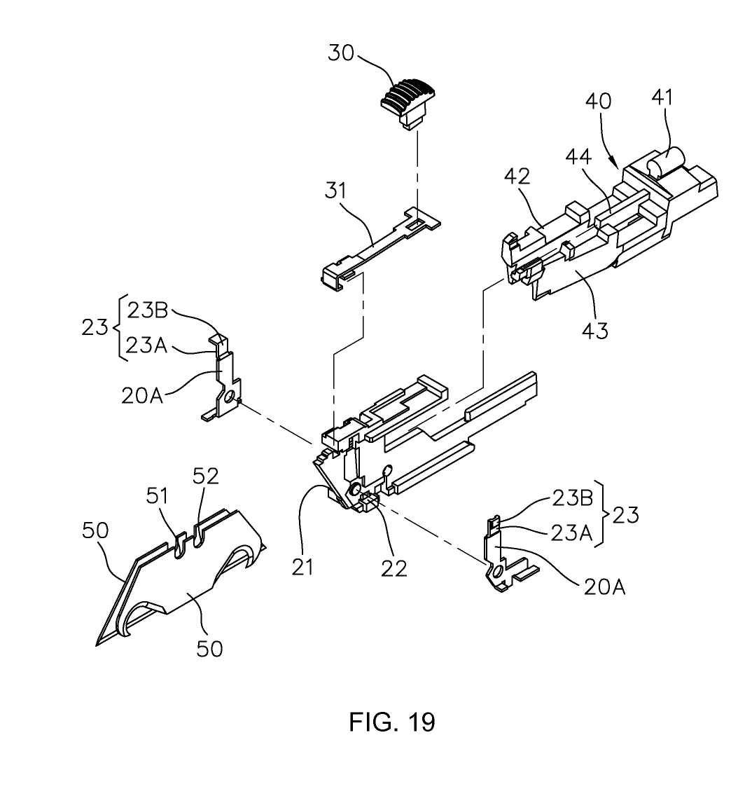

Referring to FIG. 19, which schematically shows an exploded view of the blade slider 20, the slide actuator 30 and the gravity switch base 40, the blade slider 20 comprises two fixing resilient plates 20A fixed to the first and second blade compartments 21, 22, respectively. The fixing resilient plates 20A extend to form the fixing bulges 23. The slide actuator 30 comprises a fixing buckle 31 for buckling the slide actuator 30 with the blade slider 20.

Furthermore, as shown in FIGS. 18 and 19, each of the fixing bulges 23 comprises an engaging part 23A and a releasing part 23B. The engaging parts 23A are used to engage with the first concave portions 51 of the blades 50, and the releasing parts 23B correspond to pushing positions of the pushing elements 10E. When the pushing elements 10E are pressed to push the releasing parts 23B, the fixed resilient plates 20A accordingly bend toward a middle of the blade slider 20 so as to disengage corresponding first concave portions 51 of the blades 50 from the fixing bulge 23, and thus to dismantle the blades 50 for blade replacement or change of cutting blade ends (i.e., changing blade orientation of the dismantled blades 50 and assembling the blades 50 back to the utility knife via engagement between the second concave portion 52 and the fixing bulge 23, and continuing cutting by use of the other cutting blade end of the blades 50).

Accordingly, the present invention has advantages and effects as follows:

[1] Quick switch of blades for use: Conventional utility knifes are equipped with only one blade for use. When the blade becomes worn out and dull or different blades are in need, it is necessary to detach and replace the original blade and is very inconvenient for use. In contradistinction, the utility knife of the present invention is capable of being equipped with two blades 50, and the blades 50 can be selectively switched by tilting the housing 10 in use of gravity for such blade switching. Accordingly, the present invention has advantages of ability to switch blades.

[2] Convenient carrying: Conventionally, when continuously and alternately using different types of blades is necessary for particular working content, multiple utility knifes will generally be prepared to perform such working content. However, such way causes problems of inconvenient carrying and cost consumption, etc. In contradistinction, the present invention utilizes blade 50 switching to alternately use different blades based on different working contents. It is no need to carry two utility knifes and thus the present invention has advantages of convenient carrying.

While the present invention is demonstrated herein with reference to the preferred embodiments, it is to be understood that the foregoing embodiments may be slightly modified or changed without departing from the spirit and scope of the present invention.

What is claimed is:

1. A utility knife using tilting status thereof for blade switching, comprising:
a housing defining an internal space therein, an opening, a sliding slot, a pair of first limit portions and a pair of second limit portions;
a blade slider received in the internal space of the housing to slidably move backwards and forwards within the internal space and to be capable of moving to at least a blade retraction position and a blade protrusion position, the blade slider comprising a first blade compartment and a second blade compartment, a fixing bulge formed in each of the first and second blade compartments;
a slide actuator fixedly disposed on the blade slider, and installed and slidably movable in the sliding slot; and
a pair of blades respectively disposed in the first and second blade compartments, each blade of the pair of blades comprising a first concave portion and a second concave portion and being capable of being placed in an operative position and a non-operative position;
wherein when the housing is tilted towards the first blade compartment, the blade received in the first blade compartment is moved by gravity to be tilted to the non-operative position thereof so as to allow the first and second concave portions of the blade received in the first blade compartment to respectively engage with the pair of first limit portions, the blade received in the second blade compartment remains in the operative position thereof with the first concave portion thereof engaging with the fixing bulge of the second blade compartment, the blade slider is then capable of advancing forward from the blade retraction position to the blade protrusion position by pushing the slide actuator, and simultaneously moving the blade received in the second blade compartment to extend out of the opening, and when the housing is tilted towards the second blade compartment, the blade received in the second blade compartment is moved by gravity to be tilted to the non-operative position thereof so as to allow the first and second concave portions of the blade received in the second blade compartment to respectively engage with the pair of second limit portions, the blade received in the first blade compartment remains in the operative position thereof with the first concave portion thereof engaging with the fixing bulge of the first blade compartment, the blade slider is then capable of advancing forward from the blade retraction position to the blade protrusion position by pushing the slide actuator, and simultaneously moving the blade received in the first blade compartment to extend out of the opening.

2. The utility knife of claim 1, wherein the housing further comprises a storage space and a movable cover, the storage space is used for storing blades therein, and the movable cover is disposed at an opening of the storage space for opening or closing the storage space.

3. The utility knife of claim 1, further comprising a gravity switch base comprising a moving portion, a first guiding bar, a second guiding bar, and a reacting portion, and the housing comprising a connecting portion, the moving portion being disposed on the connecting portion of the housing, the gravity switch base being movable between a first pushing position and a second pushing position based on tiling of the housing, wherein when the housing is tilted towards the first blade compartment, the gravity switch base is located in the first pushing position thereof so as to allow the reacting portion pushing against the blade received in the first blade compartment toward the non-operative position thereof, and to allow the second guiding bar pushing and maintaining the blade received in the second blade compartment in the operative position thereof, and when the housing is tilted towards the second blade compartment, the gravity switch base is located in the second pushing position thereof so as to allow the reacting portion pushing against the blade received in the second blade compartment to the non-operative position thereof, and to allow the first guiding bar pushing and maintaining the blade received in the first blade compartment in the operative position thereof.

4. The utility knife of claim 3, wherein the moving portion is pivotally connected to the connecting portion of the housing so that the gravity switch base pivotally rotates around the connecting portion to one of the first and second pushing positions of the gravity switch base.

5. The utility knife of claim 3, wherein the moving portion is slidably disposed on the connecting portion of the housing so that the gravity switch base is movable to one of the first and second pushing positions of the gravity switch base as the moving portion slides.

6. The utility knife of claim 3, further comprising a position switch, wherein the position switch comprises an engaging portion having a first engaging face and a second engaging face, the housing further comprises a switch channel, and the gravity switch base further comprises a position part, the position switch is slidably disposed in the switch channel and is movable between at least an opening position and an engaging position, wherein when the position switch is located in the open position thereof, the gravity switch base is capable of freely moving to the first and second pushing positions thereof, when the gravity switch base is located in the first pushing position thereof, the position part of the gravity switch base is capable of engaging with the first engaging face of the engaging portion by pushing the position switch from the open position to the engaging position so as to limit and fix the gravity switch base in the first pushing position thereof, and when the gravity switch base is located in the second pushing position thereof, the position part of the gravity switch base is capable of engaging with the second engaging face of the engaging portion by pushing the position switch from the open position to the engaging position so as to limit and fix the gravity switch base in the second pushing position thereof.
